(19) United States
(12) Patent Application Publication
(10) Pub. No.: US 2003/0091277 A1
(43) Pub. Date: May 15, 2003

(54) Flattened laser scanning system

(76) Inventor: Wenhui Mei, Plano, TX (US)

Correspondence Address: HAYNES AND BOONE, LLP, 901 MAIN STREET, SUITE 3100, DALLAS, TX, 75202, US

(21) Appl. No.: 09/683,075

(22) Filed: Nov. 15, 2001

(51) Int. Cl. G02B 6/32; G02B 6/26

(52) U.S. Cl. 385/33; 385/31

(57) ABSTRACT

Attorney Docket No. 22397.298A system and method for an imaging system is provided. The system utilizes multiple optic fibers arranged so that the input ends of the fibers are positioned around an oval and the output ends are positioned in a line. An axis runs through the center of the oval. One or more laser diodes or LEDs may be used to project light into the fibers. The diodes may be rotated around the axis to scan across the input end of each fiber or a redirection device, such as a parallel glass, may be used to scan the light from one or more stationary diodes across the input ends of the fibers.

### BACKGROUND

The present invention relates generally to imaging systems, and more particularly, to a system and method for controllably projecting light.

Imaging systems frequently utilize one or more light sources during scanning processes. For example, a photolithography system may use a light source such as a mercury lamp to project an image onto a substrate. Within the photolithography system, light projected by the light source may be redirected by a pixel panel or other reflective device to control the path of the light.

In general, imaging systems lack flexibility with respect to how light is transmitted within the system, how the system delivers light to the subject, and similar issues. For example, an imaging system may limit the position of a light source to a fixed location relative to other components of the system. In an imaging system which may be utilized for scanning, such a limitation may restrict the means by which the system is able to convey the light from the light source to the substrate or other subject.

Accordingly, certain improvements are desired for imaging systems. For one, it is desirable to provide a light source which may be selectively positioned relative to other components of the system. In addition, it is desired to have a relatively large exposure area, to provide good image resolution, to provide good redundancy, to provide high light energy efficiency, to provide high productivity and resolution, and to be more flexible and reliable.

### SUMMARY

A technical advance is provided by a novel system and method for projecting light onto a subject. In one embodiment, the system includes at least one light source operable to emanate light and a plurality of optic fibers. Each fiber includes a receiving end and a projecting end, wherein the receiving ends are positioned to receive light emanating from the light source and the projecting ends are positioned proximate to the subject. The system also includes a lens positioned between the light source and the receiving ends to couple the light source with at least one of the receiving ends. This enables light to be received by the receiving end of at least one fiber, transferred through the fiber, and projected by the projecting end of the fiber towards the subject.

In another embodiment, the receiving ends are positioned in a first oval. The first oval lies in a first plane perpendicular to an axis positioned proximate to the center point of the first oval.

In still another embodiment, the light source is rotatable around the axis in a second oval that includes a corresponding position for the position of each receiving end on the first oval. This enables the receiving end of each fiber on the first oval corresponding to the position of the light source on the second oval to receive light emanating from the light source and project the received light onto the subject.

In yet another embodiment, the second oval lies in a second plane parallel to the first plane. In still another embodiment, the second oval lies in the first plane and is contained within the first oval.

### BRIEF DESCRIPTION OF DRAWINGS

FIG. 1 is a diagrammatic view of an improved digital photolithography system for implementing various embodiments of the present invention.

FIG. 2 illustrates an exemplary point array aligned with a subject.

FIG. 3 illustrates the point array of FIG. 2 after being rotated relative to the subject.

FIG. 4 illustrates a portion of an imaging system utilizing a laser diode array in conjunction with a pixel panel.

FIG. 5 illustrates the laser diode array of FIG. 4.

FIG. 6 illustrates the imaging system of FIG. 4 without the pixel panel.

FIG. 7 illustrates utilizing the laser diode array of FIG. 5 as a high power light source.

FIG. 8 illustrates the laser diode array of FIG. 4 configured to rotate around an axis.

FIG. 9 illustrates a plurality of laser diodes projecting light through optic fibers and multiple lenses onto a subject.

FIG. 10 illustrates a plurality of the laser diodes shown in FIG. 9 projecting light through associated optic fibers and a single lens to expose an area of a subject.

FIG. 11 illustrates an optic fiber bundle positioned to receive light from a laser diode which rotates around an axis.

FIG. 12 illustrates a fiber optic bundle positioned as shown in FIG. 11 with a plurality of laser diodes.

FIG. 13 illustrates the fiber optic bundle and laser diodes shown in FIG. 12 projecting light through a single lens to expose an area of a subject.

FIG. 14 illustrates a series of “tracks” created on a subject by the laser diodes shown in FIG. 13.

FIG. 15 illustrates the optic fiber bundle of FIG. 11 arranged in an alternative manner to receive light from multiple laser diodes.

FIG. 16 illustrates two of the optic fiber bundles of FIG. 15 projecting light through associated lenses to expose multiple areas of a subject.

FIG. 17 illustrates an optic fiber bundle associated with a redirection device positioned between a single laser diode and the optic fiber bundle.

FIG. 18 illustrates the fiber optic bundle shown in FIG. 17 with a lens positioned between the redirection device and a subject.

### DETAILED DESCRIPTION

The present disclosure relates to imaging systems, and more particularly, to a system and method for controllably projecting and redirecting light. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

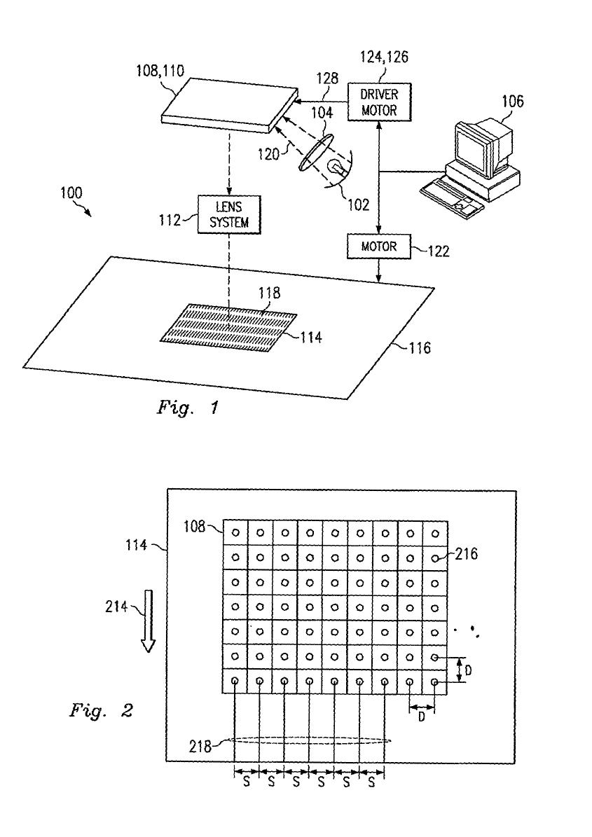

Referring now to FIG. 1, a maskless photolithography system 100 is one example of a system that can benefit from the present invention. In the present example, the maskless photolithography system 100 includes a light source 102, a first lens system 104, a computer aided pattern design system 106, a pixel panel 108, a panel alignment stage 110, a second lens system 112, a subject 114, and a subject stage 116. A resist layer or coating 118 may be disposed on the subject 114. The light source 102 may be an incoherent light source (e.g., a Mercury lamp) that provides a collimated beam of light 120 which is projected through the first lens system 104 and onto the pixel panel 108. Alternatively, the light 102 source may be an array comprising, for example, laser diodes or light emitting diodes (LEDs) that are individually controllable to project light.

The pixel panel 108, which may be a digital mirror device (DMD), is provided with digital data via suitable signal line(s) 128 from the computer aided pattern design system 106 to create a desired pixel pattern (the pixel-mask pattern). The pixel-mask pattern may be available and resident at the pixel panel 108 for a desired, specific duration. Light emanating from (or through) the pixel-mask pattern of the pixel panel 108 then passes through the second lens system 112 and onto the subject 114. In this manner, the pixel-mask pattern is projected onto the resist coating 118 of the subject 114.

The computer aided mask design system 106 can be used for the creation of the digital data for the pixel-mask pattern. The computer aided pattern design system 106 may include computer aided design (CAD) software similar to that which is currently used for the creation of mask data for use in the manufacture of a conventional printed mask. Any modifications and/or changes required in the pixel-mask pattern can be made using the computer aided pattern design system 106. Therefore, any given pixel-mask pattern can be changed, as needed, almost instantly with the use of an appropriate instruction from the computer aided pattern design system 106. The computer aided mask design system 106 can also be used for adjusting a scale of the image or for correcting image distortion.

In some embodiments, the computer aided mask design system 106 is connected to a first motor 122 for moving the stage 116, and a driver 124 for providing digital data to the pixel panel 108. In some embodiments, an additional motor 126 may be included for moving the pixel panel. The system 106 can thereby control the data provided to the pixel panel 108 in conjunction with the relative movement between the pixel panel 108 and the subject 114.

Efficient data transfer may be one aspect of the system 106. Data transfer techniques, such as those described in U.S. provisional patent application Serial No. 60/278,276, filed on Mar. 22, 2001, and also assigned to Ball Semiconductor, Inc., entitled “SYSTEM AND METHOD FOR LOSSLESS DATA TRANSMISSION” and hereby incorporated by reference as if reproduced in its entirety, may be utilized to increase the throughput of data while maintaining reliability. Some data, such as high resolution images, may present a challenge due in part to the amount of information needing to be transferred.

The pixel panel 108 described in relation to FIG. 1 has a limited resolution which depends on such factors as the distance between pixels, the size of the pixels, and so on. However, higher resolution may be desired. Such improved resolution may be achieved as described below and in greater detail in U.S. patent application Ser. No. 09,923,233, filed on Aug. 3, 2001, and also assigned to Ball Semiconductor, Inc., entitled “REAL TIME DATA CONVERSION FOR A DIGITAL DISPLAY” and hereby incorporated by reference as if reproduced in its entirety.

Referring now to FIG. 2, the pixel panel 108 (comprising a DMD) of FIG. 1 is illustrated. The pixel panel 108, which is shown as a point array for purposes of clarification, projects an image (not shown) upon the subject 114, which may be a substrate. The substrate 114 is moving in a direction indicated by an arrow 214. Alternatively, the point array 108 could be in motion while the substrate 114 is stationary, or both the substrate 114 and the point array 108 could be moving simultaneously. The point array 108 is aligned with both the substrate 114 and the direction of movement 214 as shown. A distance, denoted for purposes of illustration as “D”, separates individual points 216 of the point array 108. In the present illustration, the point distribution that is projected onto the subject 114 is uniform, which means that each point 216 is separated from each adjacent point 216 both vertically and horizontally by the distance D.

As the substrate 114 moves in the direction 214, a series of scan lines 218 indicate where the points 216 may be projected onto the substrate 114. The scan lines are separated by a distance “S”. Because of the alignment of the point array 108 with the substrate 114 and the scanning direction 214, the distance S between the scan lines 218 equals the distance D between the points 216. In addition, both S and D remain relatively constant during the scanning process. Achieving a higher resolution using this alignment typically requires that the point array 108 embodying the DMD be constructed so that the points 216 are closer together. Therefore, the construction of the point array 108 and its alignment in relation to the substrate 114 limits the resolution which may be achieved.

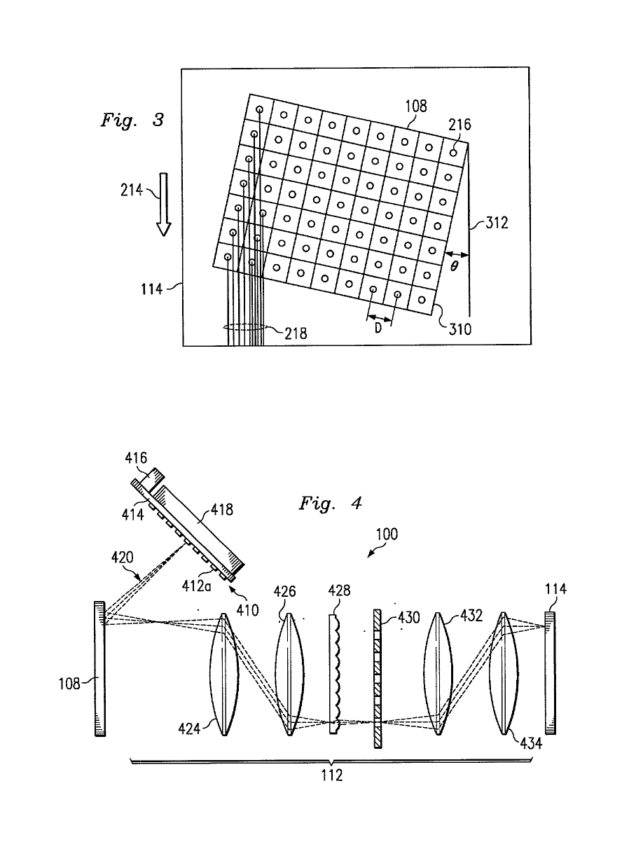

Referring now to FIG. 3, a higher resolution may be achieved with the point array 108 of FIG. 2 by rotating the DMD embodying the point array 108 in relation to the substrate 114. The rotation is identified by an angle Θ between an axis 310 of the rotated point array 108 and a corresponding axis 312 of the substrate. As illustrated in FIG. 3, although the distance D between the points 216 remains constant, such a rotation may reduce the distance S between the scan lines 218, which effectively increases the resolution of the point array 108. The image data that is to be projected by the point array 108 must be manipulated so as to account for the rotation of the point array 108.

The magnitude of the angle Θ may be altered to vary the distance S between the scan lines 218. If the angle Θ is relatively small, the resolution increase may be minimal as the points 216 will remain in an alignment approximately equal to the alignment illustrated in FIG. 2. As the angle Θ increases, the alignment of the points 216 relative to the substrate 114 will increasingly resemble that illustrated in FIG. 3. If the angle Θ is increased to certain magnitudes, various points 216 will be aligned in a redundant manner and so fall onto the same scan line 218. Therefore, manipulation of the angle Θ permits manipulation of the distance S between the scan lines 218, which affects the resolution of the point array 108. It is noted that the distance S may not be the same between different pairs of scan lines as the angle Θ is altered.

Referring now to FIG. 4, in another embodiment, a portion of the photolithography system 100 is illustrated using an LED array or a laser diode array 410 (both of which are hereinafter referred to as a laser diode array for purposes of clarity and described later in greater detail) as the light source 102 of FIG. 1 rather than the conventional Mercury lamp described previously. The laser diode array may be utilized to project light onto the pixel panel 108, which may be rotated as described in reference to FIGS. 2 and 3. Alternatively, the pixel panel 108 may be absent, and the laser diode array 410 may project light directly onto the lens system 112. Certain benefits may be available using the laser diode array 410. For example, higher resolution is possible using a laser diode because the light can be turned off during the mirror transition, reducing diffracted and scattered light. In addition, a smaller light source (as compared to a conventional Mercury arc lamp) improves the optical resolution by reducing the spot size at the focal point of the micro-lens array. Combining a laser diode with the rotation of a pixel panel as described in reference to FIGS. 2 and 3 may provide additional resolution benefits.

Although other relationships may be desirable, there may be a plurality of individual laser diodes for each pixel of the pixel panel 108. This enables the laser diode array 410 to provide higher exposure contrast because individual diodes may be selectively pulsed on and off to accommodate for the desired contrast level and field uniformity. In this way, if certain pixels of the pixel panel 108 are “dull,” more light can be provided to these pixels, than to other less-dull pixels. This can also solve other problems that affect the contrast level.

Referring now to FIG. 5, the laser diode array 410 of FIG. 4 is illustrated in greater detail. The laser diode array 410 comprises a plurality of laser diodes 412 embedded within or connectable to a substrate 414, which includes embedded circuitry 408. The circuitry 408, which may include embedded microelectronics and electrical connectors, is operable to provide parallel and/or serial control signals and/or address lines to the laser diode array 410. These control signals may enable the regulation of the wavelength and/or intensity of laser beams produced by the laser diode array 410. Connectable to the substrate 414 is a connector 416, which enables a computer aided design system (not shown) to control the laser diode array 410 through the circuitry 408. Proximate to the substrate 414 is a cooler 418, which may be a thermo-electric cooler such as a Peltier cooler. The cooler 418 permits uniform cooling to stabilize the performance of the laser diode array 410. The laser diode array 410 may also include memory (not shown), either embedded into the substrate 414 or made accessible to the array 410 using other common techniques.

Referring again to FIG. 4, the operation of a single laser diode 412a from the laser diode array 410 is described. The laser diode 412a projects a laser beam 420, which may be of varying wavelengths and intensity. The wavelength and intensity of the beam 420 may be altered to achieve a desired result. For example, the intensity and/or wavelength of the beam 420 may be altered by regulating the current supplied to the laser diode 412a. Such regulation may be exercised on an individual diode basis or multiple laser diodes 412 may be controlled at once.

The shape of the beam 420 projected by the laser diode 412 and reflected off the pixel panel 108 may be distorted relative to some desired beam shape, and so may require correction. Therefore, the beam 420 may be passed through the lens system 112 of FIG. 1, which may include a plurality of optical devices, including an aspherical or cylindrical lens array (not shown) to reshape the beam into the desired shape. For example, the laser diode 412a may produce a beam 420 having an oval shape, instead of a desired circular shape. Therefore, the lens array would be utilized to reshape the oval beam into a circular beam. The laser beam 420 passes through a pair of lenses 424, 426 and then a micro-lens array 428. The micro-lens array 428, which is a multi-focus device, may produce a one or two dimensional point array. The beam 420 then passes through a grating 430, which may take on various forms, be placed in alternate locations, and in some embodiments, may be replaced with another device or not used at all. The beam 420 then passes through a second set of lenses 432, 434 before striking the surface of the subject 114.

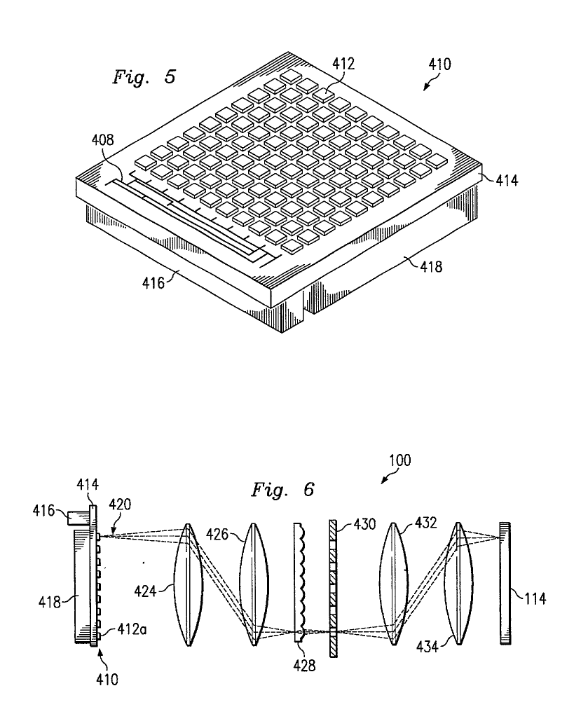

Referring now to FIG. 6, in another embodiment, the laser diode array 410 of FIG. 4 is illustrated projecting light directly onto the lens system 112 rather than onto the pixel panel 108. As previously described, the laser diode array 410 may be rotated as described in relation to FIGS. 2 and 3. The lens system 112 in the present example is the same as that described in reference to FIG. 4.

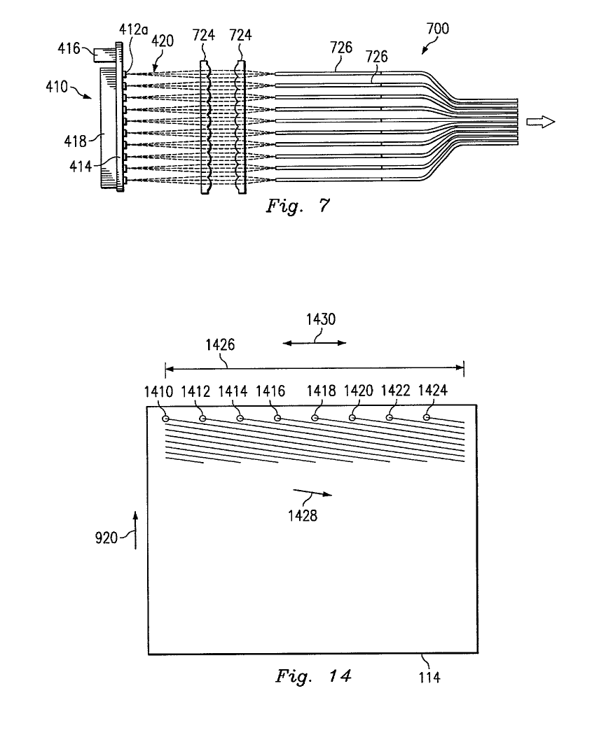

Referring now to FIG. 7, in yet another embodiment, the laser diode array 410 of FIGS. 4 and 5 may be utilized as a high power light source 700 by combining the output of multiple laser diodes 412. The laser diodes 412 of the array 410, of which only ten are illustrated for the sake of clarity, project laser beams 420. The beams 420 may pass through a lens array (not shown) for any desired reshaping of the beams 420 as described above in reference to FIG. 4. The beams 420 then pass through a micro-lens array 724. The micro-lens array 724 provides enhanced coupling between the laser diodes 412 and multiple multimode optic fibers 726. The fibers 726 may be bundled into one or more outputs, which may transfer the light to optics for beam reshaping, decorrelation, and/or the application of other techniques. The output may be used for photolithography, as a laser pump for other lasing media, or in a variety of other applications where such a high power light source may be desired. It is noted that there may be a one-to-one correspondence between each laser diode 412 and each optic fiber 726, or there may be a plurality of laser diodes 412 for each optic fiber 726.

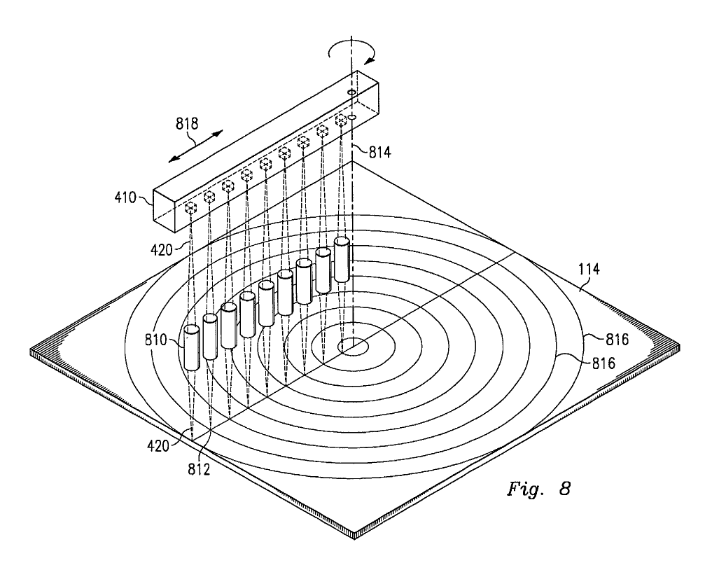

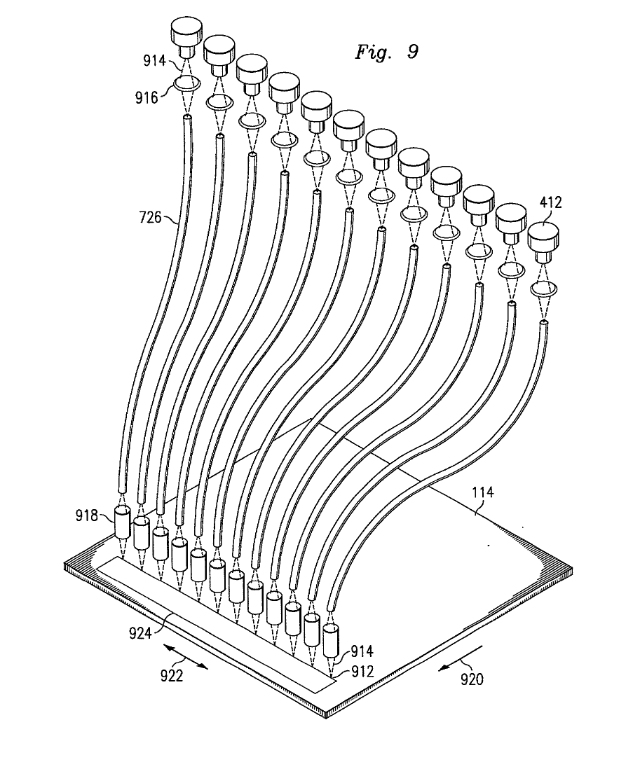

Referring now to FIG. 8, in another embodiment, a laser diode array 410 is positioned above the subject 114 in the photolithography system 100. The array 410 is operable to project a plurality of beams 420 onto a plurality of associated lenses 810, which may comprise the lens system 112 of FIG. 1. The lenses 810 may focus and direct the beams 420 onto the subject 114 to form a plurality of points 812 as described previously.

The array 410 may rotate relative to the subject 114 around an axis 814. The rotation of the array 410 around the axis 814 enables the projected points 812 to form a circular pattern indicated by “tracks” 816. The array 410 may also be moved in a direction perpendicular to the circular pattern as indicated by an arrow 818, enabling the array 410 to create overlapping projection areas with the points 812. Accordingly, the rotation of the array 410 combined with movement in the direction 818 enables the array 410 to expose areas of the subject 114 as desired. The circular pattern produced by the tracks 816 may be utilized with both planer and non-planer subjects. For example, the circular pattern may be used on a spherical subject.

In the present example, the axis 814 is perpendicular to the surface of the subject 114, but it is understood that the angle between the axis 814 and the subject 114 may be altered as desired. Additionally, the position of the array 410 may be altered relative to the axis 814 to change parameters such as rotation speed and/or the positioning of the tracks 816. The orientation of the array 410 relative to the axis 814 may also be altered. For example, if the subject 114 is spherical, the array 410 may be oriented in such a way as to maximize the exposure area provided by the tracks 816.

Referring now to FIG. 9, in another embodiment, a plurality of laser diodes 412 are coupled with a plurality of optic fibers 726, such as those described above in reference to FIG. 7. The coupling may be enhanced using a plurality of coupling lenses 916, which direct a beam 914 from each laser diode 412 into the associated fiber 726.

The fibers 726 direct the beams 914 onto lenses 918, which may reshape, focus, and direct the beams 914 onto a plurality of points 912 on the subject 114. As the subject 114 moves in a direction 920 relative to the lenses 918, the beams 914 scan the surface of the subject 114. Additionally, the lenses 918 and/or the subject 114 may be moved back and forth in a vibratory motion as indicated by an arrow 922 perpendicular to the direction 920. Such vibration may, for example, enable the points 912 to overlap on the subject 114 to more fully cover an exposure site 924. Although not illustrated in the present example, the lenses 918 may be rotatably positioned as described in relation to FIGS. 2 and 3.

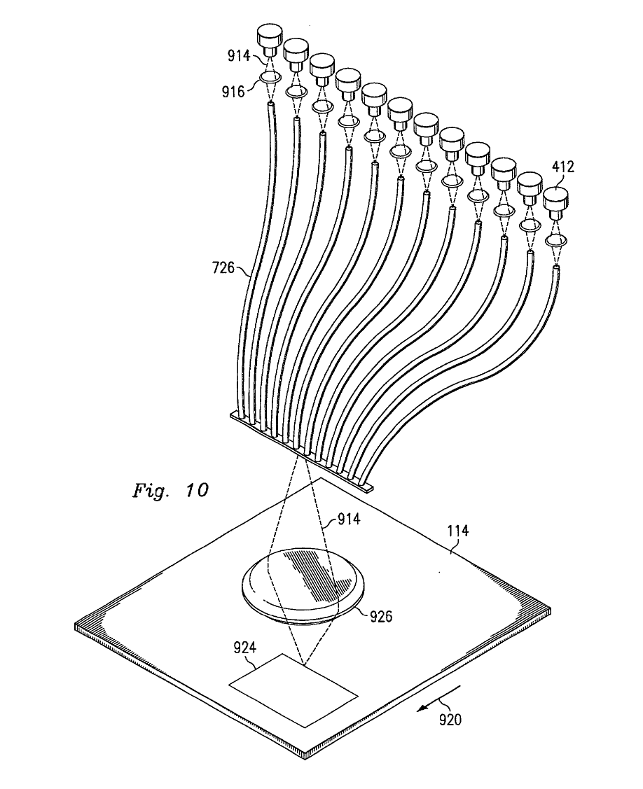

Referring now to FIG. 10, in another embodiment, the plurality of laser diodes 412 project laser beams 914 through a plurality of coupling lenses 916 and into optic fibers 726 as previously described in relation to FIG. 9. The optic fibers 726 transfer the beams 914 onto an image lens 926, which directs the beams 914 onto the subject 114. In the present example, which illustrates a single beam 914 being projected from a single fiber 726 onto the image lens 926, the image lens 926 may reshape, focus and direct multiple beams 914 towards the subject 114 while maintaining the individuality of each beam 914. In other embodiments, the image lens 926 may combine multiple beams 914 and direct them towards the subject 114 as a single beam. As the subject 114 moves relative to the lens 926 in a direction 920, the beams 412 are scanned across the subject 114 to expose the site 924. Movement in additional directions may be utilized to more fully cover the exposure site 924.

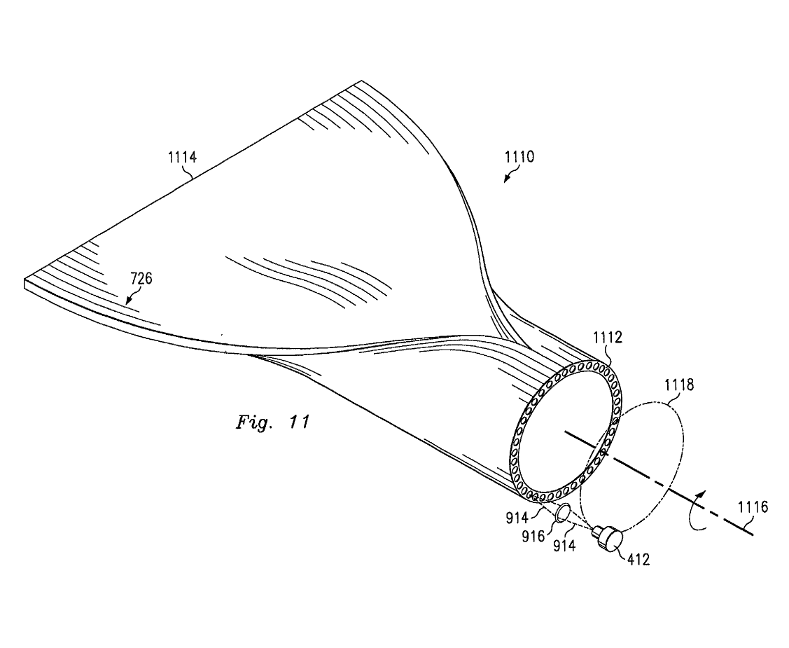

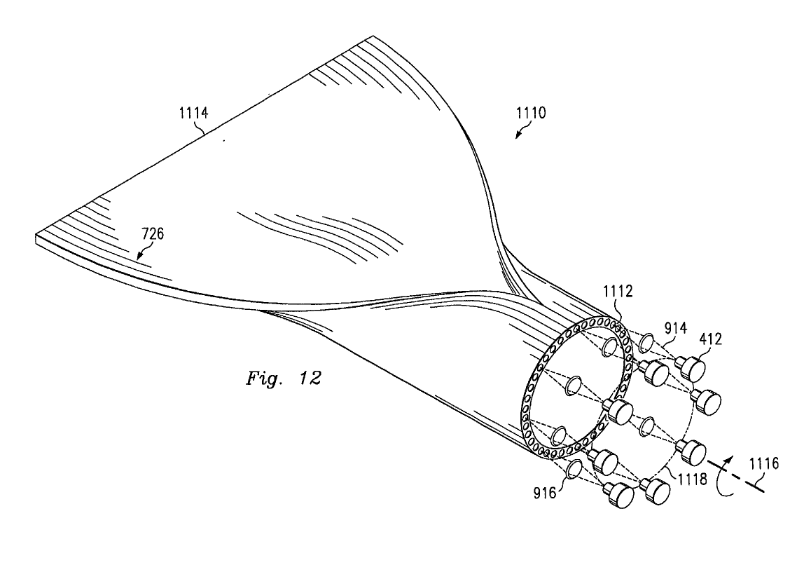

Referring now to FIG. 11, a fiber optic bundle 1110 comprising a single layer of fibers 726 is utilized to convey light from a single laser diode 412. One end of the bundle 1110 is formed into an oval 1112, which may be a circle, while the opposite end is flattened into a planer line 1114. In the present example, the circular end 1112 receives input from the laser diode 412 while the linear end 1114 outputs light. An axis 1116 is defined through the center of the circle 1112. The laser diode 412, which may be coupled to the circular end 1112 of the bundle 1110 using a coupling lens 916, may be rotated around the axis 1116.

In operation, the laser diode 412 projects a beam 914 through the coupling lens 916 and a fiber 726 of the bundle 1110. The fiber 726 then transfers the beam 914 towards a desired destination. During the period when the laser diode 412 is off (e.g., not projecting the beam 914), the laser diode 412 and the lens 916 may be rotated around the circle 1112 formed by the input end of the bundle 1110. The rotation may occur along a path 1118 which mirrors the circle 1112. The rotation positions the laser diode 412 proximate to each fiber 726 in a sequential manner. Accordingly, if the laser diode 412 is projecting light when it is positioned relative to each fiber 726, then one complete rotation around the axis 1116 by the laser diode 412 will be operable to project light through each fiber 726 of the bundle 1110. It is noted that the laser diode 412 may be turned on and off as desired to project or not project light onto specific fibers 726 of the bundle 1110, resulting in a controllable output from the linear end 1114. In some applications, it may be desirable to rotate the laser diode 412 around the axis 1116 when the laser diode 412 is projecting light.

The positioning of the fibers 726 of the bundle 1110 and the rotation of the light source 412 may provide certain benefits in comparison to conventional methods. For example, scanning a single laser diode across a straight line of fibers (such as the output end of the bundle 1110) generally requires that the laser diode scan in one direction, stop, and then scan back. Such scanning lacks continuity and may add complexity to the scanning system. In contrast, the present example provides for continuous scanning because the laser diode 412 may be rotated around the circle 1112 of fibers 726 without cessation. It is noted that more complex bundles 1110 may be constructed using, for example, multiple layers of fibers 726.

Referring now to FIG. 12, in yet another embodiment, the fiber optic bundle 1110 of FIG. 11 may be utilized with a plurality of laser diodes 412 and coupling lenses 916. The plurality of diodes 412 enables the projection of light into multiple fibers 726 simultaneously. The laser diodes 412 and corresponding lenses 916 may be rotated as a single unit around the axis 1116, or each laser diode 412 and corresponding lens 916 may be rotated individually. It is noted that each laser diode 412/lens 916 may be located at a different distance from the bundle 1110 to facilitate individual rotation.

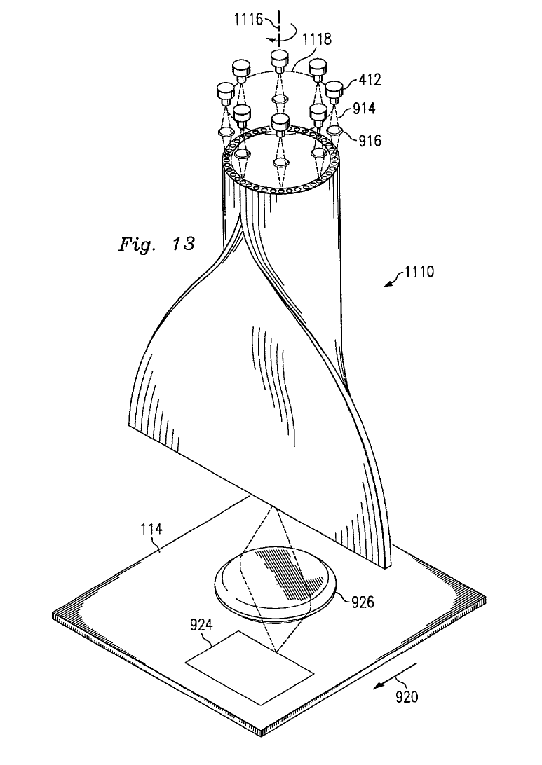

Referring now to FIG. 13, in another embodiment, the fiber optic bundle 1110 of FIG. 12 directs beams 914 onto an image lens 926. In the present example, which illustrates a single beam 914 being projected from a single fiber 726 onto the image lens 926, the image lens 926 may reshape, focus and direct multiple beams 914 towards the subject 114 while maintaining the individuality of each beam 914. In other embodiments, the image lens 926 may combine multiple beams 914 and direct them towards the subject 114 as a single beam. As the subject 114 moves relative to the lenses 926 in a direction 920, the beams scan the subject 114. It is noted that a plurality of bundles 1110 may be utilized with associated diodes 412, coupling lenses 916, and image lenses 926 to simultaneously expose a plurality of sites 924 on the subject 114.

Referring now to FIG. 14, a plurality of tracks 1410-1424 are illustrated on a portion of the subject 114 of FIG. 13. The tracks 1410-1424 are representative of tracks which may be created by the single image lens 926 on the site 924. Accordingly, each track 1410-1424 represents the projection of a beam from a single laser diode (not shown). For purposes of clarity, only the track 1410 will be discussed.

The linear output end 1114 of the bundle 1110 is of width 1426. As the laser diode 412 associated with the track 1410 rotates around the circular end 1112 of the bundle 1110, the beam 914 projected by the laser diode 412 scans through the different fibers 726 of the corresponding bundle 1110. This scanning may occur while the subject 114 is moving in the direction 920 relative to the image lens 926. Accordingly, the beam impacts a plurality of points (illustrated as the track 1410) which move in the direction 1428 during the scanning process. The subject 114 may be also be moved in a direction 1430 relative to the laser diode during the scanning process to more fully expose the subject 114. Additionally, the density of tracks (e.g., the number of tracks in a given distance) may be adjusted by, for example, using more laser diodes and/or reducing the number of fibers between each laser diode.

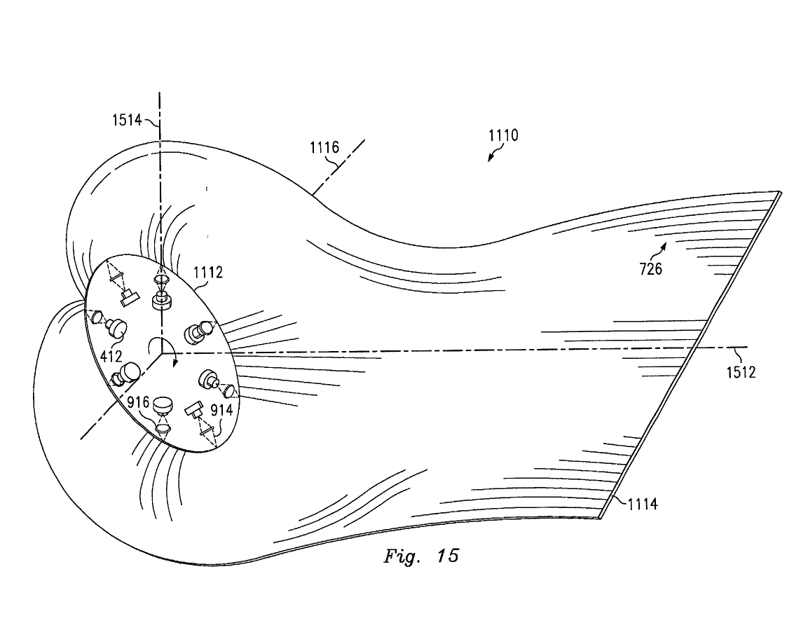

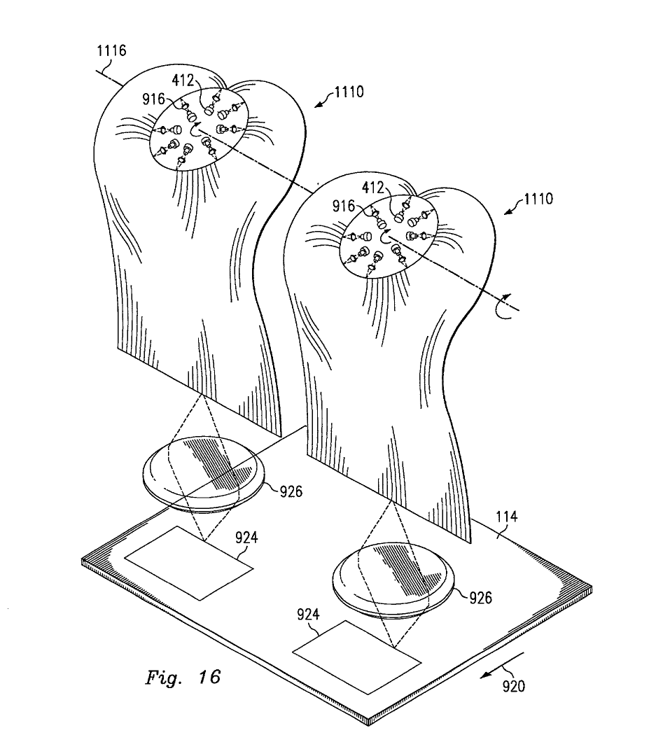

Referring now to FIG. 15, in yet another embodiment, the fiber optic bundle 1110 is associated with multiple laser diodes 412. As previously described, each laser diode 412 is associated with a coupling lens 916. In the present example, the bundle 1110 is positioned in a three-dimensional coordinate system comprising an x-axis 1116, a y-axis 1512, and a z-axis 1514. The circular end 1112 of the bundle 1110 has the x-axis 1116 as its center point, while the linear end 1114 is arranged along the y-axis 1512. As described previously, the circular end 1112 receives input from the laser diodes 412 while the linear end 1114 projects light as output. The laser diodes 412 and image lenses 926 may rotate around the x-axis 1116 to scan the laser diodes 412 through the individual fibers 726 of the bundle 1110 as described previously.

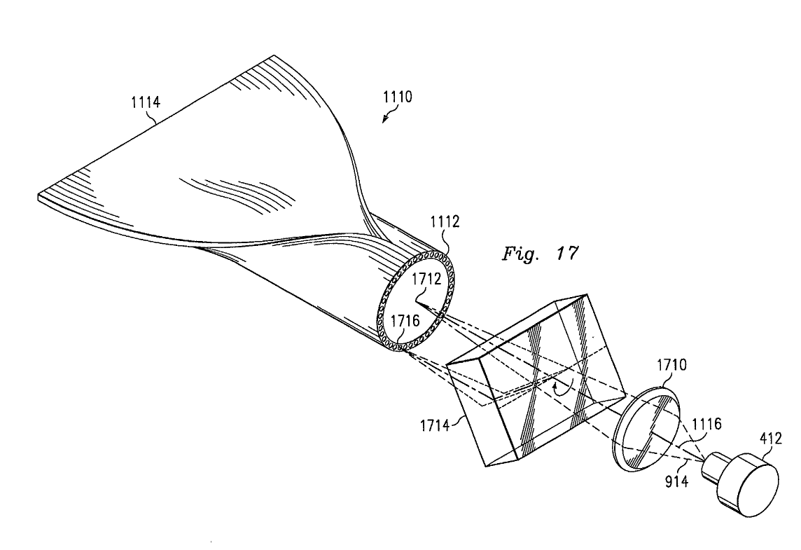

Referring now to FIG. 16, in another embodiment, two fiber optic bundles 1110 of FIG. 15 direct beams 914 projected by the laser diodes 412 onto the subject 114. As described in reference to FIG. 15, the laser diodes 412 associated with each bundle 1110 may rotate around their respective x-axis 1116. Although each bundle 1110 may utilize an individual x-axis 1116, it may be desirable to position all of the bundles 1110 relative to a single x-axis 1116. Such a single axis approach may facilitate the control of the various diodes 412 associated with different bundles 1110.

The fibers 726 of each bundle 1110 transfer the beams 914 onto image lenses 926, which direct the beams 914 onto the subject 114. In the present example, which illustrates a single beam 914 being projected from a single fiber 726 of each bundle 1110 onto each image lens 926, the image lenses 926 may reshape, focus and direct multiple beams 914 towards the subject 114 while maintaining the individuality of each beam 914. In other embodiments, each image lens 926 may combine multiple beams 914 and direct them towards the subject 114 as a single beam. As the subject 114 moves relative to the lenses 926 in a direction 920, the beams 914 scan the subject 114 on exposure sites 924.

Referring now to FIG. 17, in another embodiment, the fiber optic bundle 1110 is associated with a single laser diode 412. The laser diode 412 is operable to project a laser beam 914 onto a lens 1710. The lens 1710 is positioned relative to the bundle 1110 so that the lens 1710 may direct the beam 914 onto a point 1712 at or near the center of the circle 1112 comprising the input end of the bundle 1110.

A redirection device 1714, such as a parallel glass, is positioned between the bundle 1110 and the lens 1710. The glass 1714 serves to redirect the beam 914 onto a projection point 1716, which may be the end of one of the fibers 726 of the bundle 1110. The glass 1714 rotates around the axis 1116 which may run through the center of the laser diode 412, the center of the lens 1710, and the center of the circular end 1112 of the bundle 1110. Accordingly, rather than scanning the laser diode 412 across the fibers 726 by rotating the laser diode 412 around the axis 1116 as previously described, in the present example, the orientation of the glass 1714 is altered to scan the projection point 1716 through the fibers 726 of the bundle 1110.

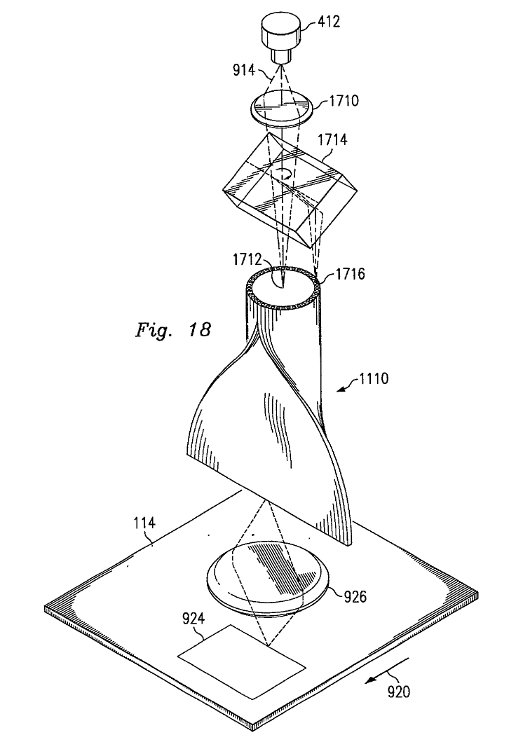

Referring now to FIG. 18, in another embodiment, the bundle 1110 and the associated laser diode 412, lens 1710, and redirection device 1714 as described in reference to FIG. 17 are illustrated. In the present example, an image lens 926 is positioned between the bundle 1110 and the subject 114 to manipulate and/or direct light toward the exposure site 924. As the subject 114 moves relative to the lens 926 in a direction 920, the beam 914 scans the subject 114 and exposes the site 924.

While the invention has been particularly shown and described with reference to the preferred embodiment thereof, it will be understood by those skilled in the art that various changes in form and detail may be made therein without departing from the spirit and scope of the invention. For example, it is within the scope of the present invention to use a lens system as the image lens. In addition, the optic fiber bundle may be positioned relative to one or more axes in a variety of different ways as desired. Also, it may be desirable to arrange the optic fiber bundle differently. For example, the output end of the optic fiber bundle may be arranged as an oval to scan a spherical subject. Also, multiple diodes may be utilized with a single redirection device. Therefore, the claims should be interpreted in a broad manner, consistent with the present invention.

What is claimed is:

1. A system for projecting light onto a subject, the system comprising:
at least one light source operable to emanate light;
a plurality of optic fibers, each fiber including a receiving end and a projecting end, wherein the receiving ends are positioned to receive light emanating from the light source and the projecting ends are positioned proximate to the subject;
a first lens positioned between the light source and the receiving ends, the first lens operable to couple the light source to at least one of the receiving ends;
so that the light is emanated by the light source, directed through the first lens, received by the receiving end of at least one fiber, transferred through the at least one fiber, and projected by the projecting end of the at least one fiber towards the subject.

2. The system of claim 1 wherein the receiving ends are positioned in a first oval, the first oval lying in a first plane perpendicular to an axis positioned proximate to the center point of the first oval.

3. The system of claim 2 wherein the light source is rotatable around the axis in a second oval, the second oval including a corresponding position for the position of each receiving end on the first oval;
so that the receiving end of each fiber on the first oval corresponding to the position of the light source on the second oval is operable to receive light emanating from the light source.

4. The system of claim 3 wherein the second oval lies in a second plane parallel to the first plane.

5. The system of claim 4 wherein the second oval has the same dimensions as the first oval.

6. The system of claim 3 wherein the second oval lies in the first plane and is contained within the first oval.

7. The system of claim 1 wherein the light source is selected from a group consisting of a laser diode, a laser diode array, a light emitting diode, and a light emitting diode array.

8. The system of claim 7 further including a second lens positioned between the projecting ends and the subject to direct the projected light towards the subject.

9. The system of claim 7 wherein one of the first or second lenses is a microlens array.

10. The system of claim 2 further including a redirection device positioned between the light source and the receiving ends, the redirection device operable to selectively direct the light projected by the light source towards at least one of the receiving ends.

11. The system of claim 10 wherein the light may be selectively directed by altering the orientation of the redirection device relative to the receiving ends.

12. The system of claim 11 wherein the redirection device is a parallel glass.

13. The system of claim 10 further including a lens positioned between the light source and the redirection device, the lens operable to direct light projected by the light source towards the redirection device.

14. A system for directing light towards an exposure area on a subject, the system comprising:
a plurality of light sources; and
at least a first lens associated with the light sources, the first lens operable to direct light projected by the light sources towards the subject;
so that movement of the subject relative to the first lens is operable to scan light projected by the light sources onto the exposure area.

15. The system of claim 14 further including an optic fiber associated with each of the plurality of light sources, each fiber including a receiving end coupled to the associated light source and a projecting end proximate to the first lens.

16. The system of claim 15 further including a second lens positioned between the receiving end of each fiber and the associated light source, the second lens operable to couple the fiber to the associated light source.

17. The system of claim 14 wherein the light source is operable to rotate around an axis.

18. The system of one of claims 16 or 17 wherein the first lens is operable to move perpendicularly relative to the movement of the subject.

19. A method for projecting light onto a subject, the method comprising:
providing at least one light source;
providing a plurality of optic fibers coupled to the light source and operable to transfer light projected by the light source;
projecting light from the light source; and
transferring the light onto the subject using at least one of the fibers.

20. The method of claim 19 further including:
positioning the plurality of fibers around an axis so that a first end of each fiber is located in a plane perpendicular to the axis;
rotating the light around the axis; and
selectively directing light projected by the light source onto at least one of the fibers.

21. The method of claim 20 further including:
providing a redirection device positioned between the light source and the first ends of the fibers; and
selectively directing the light by altering the orientation of the redirection device relative to the first ends.

22. A system for projecting light onto a subject during photolithographic processing, the system comprising:
an axis positioned perpendicularly to a first plane and a second plane;
at least one light source rotatable around the axis in a first oval lying in the first plane, the light source selected from a group consisting of a laser diode, a laser diode array, a light emitting diode, and a light emitting diode array;
a plurality of optic fibers, each fiber including a receiving end and a projecting end, the plurality of fibers positioned around the axis so that the receiving ends are located in a second oval lying in the second plane and the projecting ends are positioned proximate to the subject;
a first lens positioned between the light source and the receiving ends, the first lens operable to couple the light source with at least one of the receiving ends; and
a second lens positioned between the projecting ends and the subject, the second lens operable to direct light projected from the projecting ends towards the subject;
so that, as the light source is rotated around the first oval, light is projected by the light source, directed through the first lens into at least one of the receiving ends in the second oval, transferred through the optic fiber, and directed towards the subject by the second lens.

23. The system of claim 22 wherein at least one of the first and second lenses is a microlens array.
